(19) United States
(12) Patent Application Publication
(10) Pub. No.: US 2025/0057079 A1
(43) Pub. Date: Feb. 20, 2025

(54) AGRICULTURAL WORK MACHINE WITH DRIVER ASSISTANCE SYSTEM

(71) Applicant: CLAAS Selbstfahrende Erntemaschinen GmbH, Harsewinkel (DE)

(72) Inventors: Andreas Wilken, Bissendorf (DE); Bastian Bormann, Gütersloh (DE); Tarek Kösters, Köln (DE); Matthias Domnik, Oelde (DE); Oliver Nelles, Netphen-Herzhausen (DE)

(73) Assignee: CLAAS Selbstfahrende Erntemaschinen GmbH, Harsewinkel (DE)

(21) Appl. No.: 18/808,214

(22) Filed: Aug. 19, 2024

(30) Foreign Application Priority Data
Aug. 17, 2023 (DE) 102023122014.4

(51) Int. Cl. A01D 41/127

(52) U.S. Cl. CPC A01D 41/127

(57) ABSTRACT

An agricultural work machine comprising a driver assistance system. The driver assistance system is configured to automatically monitor and set work parameters and quality parameters of the agricultural work machine and is assigned a process model comprising performance maps. The optimization method implemented by the driver assistance system is designed as a map control and generates optimized work parameters as manipulated variables. The driver assistance system determines the quality parameters of the agricultural work machine depending on the optimized work parameters. The process model comprises a dynamic non-linear process model in such a way to comprises a static process model component and a dynamic process model component. At least the manipulated variables in the static process model component execute through an optimization step and, in the dynamic process model component, through a control loop structure.

### CROSS REFERENCE TO RELATED APPLICATION

This application claims priority under 35 U.S.C. § 119 to German Patent Application No. DE 10 2023 122 014.4 filed Aug. 17, 2023, the entire disclosure of which is hereby incorporated by reference herein.

### TECHNICAL FIELD

The present invention relates to an agricultural work machine comprising a driver assistance system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Driver assistance systems that optimize the operation of agricultural work machines, such as harvesting machines, are used to relieve the operator of the agricultural work machines of monitoring and adjusting tasks. US Patent Application Publication No. 2012/004813 A1, incorporated by reference herein in its entirety, discloses a driver assistance system that determines optimized setting parameters of the working units of an agricultural harvester based on a map, whereby the optimized work parameters may be determined in an iterative process. Such systems are well-suited to quickly determine optimized work parameters of the harvesting machine under more or less homogeneous harvesting conditions.

The quality of the employed map may have a significant influence on the particular optimization result. For example, in US Patent Application Publication No. 2014/019017 A1, incorporated by reference herein in its entirety, certain operating points of the map lying outside the current operating range may be specifically approached in order to keep the map updated over a wide range of the overall map. This has in particular the effect that the mathematical relationships that determine the map are adapted in such a way that the determination of optimized work parameters is accelerated.

In order to enable a map used to optimize the work parameters of an agricultural work machine, such as a combine harvester, to quickly determine optimized work parameters, US Patent Application Publication No. 2023/099523 A1, incorporated by reference herein in its entirety, may assign to a map a so-called control characteristic which summarizes the particular optimal working points over a large range of the map, and for the driver assistance system to control the parameter optimization process along this optimal characteristic.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic view of an example agricultural work machine with the driver assistance system.

FIG. 2 illustrates details of a process model-based optimization of work parameters of the agricultural work machine.

FIG. 3 illustrates details of the process model-based optimization of work parameters of the agricultural work machine according to one aspect of the invention.

FIG. 4 illustrates a design variant of the process model-based optimization of work parameters of the agricultural work machine according to the invention as shown in FIG. 3.

### DETAILED DESCRIPTION

As discussed in the background, driver assistance systems may quickly determine optimized work parameters of the harvesting machine under more or less homogeneous harvesting conditions. However, in the case of rapidly changing harvesting conditions, such methods may have the disadvantage that, due to the inertia of the optimization method, a certain adjustment process must be run through until the harvester is again working at an optimized operating point.

Further, with regard to certain driver assistance systems, certain operating points of the map lying outside the current operating range may be specifically approached in order to keep the map updated over a wide range of the overall map. However, the disadvantage of such methods is the additional effort for the targeted control of operating points not lying in the current operating field.

In addition, certain driver assistance systems may assign to a map a so-called control characteristic, which may summarize the particular optimal working points over a large range of the map, and for the driver assistance system to control the parameter optimization process along part or all of this optimal characteristic. This may have the advantage that the optimum operating points may be reached more quickly using this map-based optimization. However, the disadvantage may be that abrupt changes in the harvesting conditions are reacted to with a residual inertia since the optimization system must first control the new optimum operating point aligned with the control characteristic.

Thus, to avoid one or more of the disadvantages described, a driver assistance system may be used that adapts quickly to the real harvesting conditions, such as reacting quickly to abrupt changes in the harvesting conditions.

In one or some embodiments, the agricultural work machine comprises a driver assistance system which is configured to automatically monitor and automatically set one or more work parameters and/or one or more quality parameters of the agricultural work machine. The driver assistance system may be assigned a process model comprising performance maps, so that the optimization method implemented by the driver assistance system may be designed as a map control. Further, the optimization method may generate one or more optimized work parameters as manipulated variables, and the driver assistance system may determine the one or more quality parameters of the agricultural work machine depending on the optimized work parameters. The process model may be designed as a dynamic non-linear process model in such a way that the dynamic non-linear process model comprises a static process model component and a dynamic process model component. At least the manipulated variable(s) in the static process model component may run through an optimization step and, in the dynamic process model component, through a control loop structure, it may be ensured that the driver assistance system may quickly adapt the optimization of the one or more work parameters to changing process conditions such as abruptly changing harvesting conditions.

In one or some embodiments, the map control defined by the process model is configured to specify the one or more work parameters of the agricultural work machine and limit values for the control loop structure. Further, a self-adjusting controller may be assigned to the control loop structure, with the self-adjusting controller configured to monitor the one or more quality parameters of the process. In particular, this may have the effect that the agricultural work machine is operated (such as always operated) at an optimum operating point.

In one or some embodiments, the optimization step and the control loop structure may form an optimization method, which may be configured to operate the process model in a model adaptation step in such a way that the dynamic non-linear process model component is configured to determine the stationary model component of the process from the monitoring of the quality parameters and using a parameter estimation method. In addition, the one or more manipulated variables comprising the optimized work parameters and the one or more quality parameters dependent on the particular manipulated variable may form input variables of the optimization method. In particular, this may have the effect that the process optimization is limited to the essential parameters so that the required computing power may be limited to a level that allows the use of the optimization method in a running harvesting operation.

In one or some embodiments, optimized manipulated variable(s) may be determined in the optimization step from the manipulated variables derived from the process model and specified quality parameters. Thus, it may first be ensured that the work parameters describing the real process may be adequately taken into account in the entire optimization process.

Several effects may be achieved in that the control loop structure comprising the self-adjusting controller may have as input variables the one or more manipulated variables optimized in the optimization step, the one or more specified quality parameters and the one or more quality parameters determined depending on the optimized manipulated variables, and in that the self-adjusting controller may further be configured to derive optimized manipulated variables from a comparison of the specified quality parameters with the determined quality parameters and to transfer them to the process and the model adaptation step of the dynamic model adaptation. On the one hand, it may be easily determined when abrupt changes in the harvesting conditions have occurred, which the usual map-based control cannot follow adequately. It may also be ensured that the optimized parameters determined by the control loop structure may also be fed to the saved process model so that it is adapted in steps, thereby describing the changed conditions of the process sufficiently more accurately.

In this context, it may be advantageous if the determined quality parameter is also transferred to the model adaptation step as an input variable so that the changed process conditions may be taken into account sufficiently accurately in the model adaptation.

The driver assistance system may then optimize the operation of the agricultural work machine sufficiently quickly if, in an advantageous further development, the driver assistance system is configured to automatically set the optimized control variables in the working units of the agricultural work machine.

In one or some embodiments, a rapid improvement in the operation of the agricultural work machine in the event of abruptly changing harvesting conditions may be achieved in that the control loop structure is configured to effect a dynamic adaptation of the process before the saved process model has been adjusted to the process.

In one or some embodiments, a particularly efficient optimization of the operation of the agricultural work machine may result if the non-linear dynamic process model describes the relationship between the work parameters of a working unit and the quality parameters.

In one or some embodiments, a mathematically simple check of the quality parameter describing the current operation of the agricultural work machine may result by structuring the limit values assigned to the quality parameters in such a way that it is determined in a test step whether or not the achieved quality parameter is still within the limit value defined for the quality parameter. Further, the control loop structure may be activated upon exceeding the limit value (e.g., the achieved quality parameter exceeds the limit value), and the activation of the control loop structure may then be omitted or terminated if the limit value is not or no longer exceeded.

In one or some embodiments, the control loop structure may remain activated until the optimized work parameters derived from the non-linear dynamic model meet the quality criteria of the process. In this way, it may be ensured that the operation of the agricultural work machine is maintained in accordance with the selected harvesting process strategy even during the adjustment of the process model to the real process conditions.

In one or some embodiments, a particularly efficient process model-based control of the operation of an agricultural work machine may be achieved if the working units of the agricultural work machine are combined into automatic process units, and one or more working units together with the driver assistance system form an automatic process unit. Process models describing the particular automatic process unit may be saved in a memory unit associated with the driver assistance system, and the computing unit may be configured to operate the automated process unit using the saved process models, and the automated process unit may be configured to optimize work parameters of the working unit or units and to specify the optimized work parameters for the particular working unit. In this context, the agricultural work machine may comprise a combine harvester and the automatic processing unit may be designed as any one, any combination, or all of: an automatic threshing unit; an automatic separating unit; an automatic cleaning unit, with a respective process model being assigned to any one, any combination, or each of these automatic processing units (e.g., the automated process units comprise: an automatic threshing unit comprising the threshing unit and an associated threshing unit process model; an automatic separating unit comprising the separating unit and an associated separating unit process model; and an automatic cleaning unit comprising the cleaning unit and an associated cleaning unit process model).

In order to optimize the computing power and shorten the optimization time, a common process model may be assigned to at least the automatic threshing unit and the automatic separating unit, such as a common process model being assigned to any one, any combination, or all of the automatic threshing unit, the automatic separating unit, and the automatic cleaning unit. This may have the effect that the required computing power significantly decreases with the reduction of the map-based models to be used.

In one or some embodiments, the dynamic non-linear process model, such as the dynamic process model component, may comprise a self-learning process model, and the parameter estimation method may be formed by a so-called LMN-FIR model (local model networks with local finite impulse response models). These models have already proven themselves and are easy to integrate into optimization routines; in particular, they may be easy to adapt to crop conditions and different machine types in an agricultural context.

The complex processes occurring in an agricultural work machine (which may comprise a combine harvester) may then be mapped particularly efficiently on the basis of a process model and converted into a correspondingly efficient optimization of the operation of a combine harvester if the optimization method is integrated into the driver assistance system assigned to the agricultural work machine. Further, the particular process model may be saved in a memory unit of the driver assistance system associated with the control and regulation device accommodating the computing unit so that the computing unit is configured to operate the optimization method using the saved process model and the driver assistance system is furthermore configured to perform any one, any combination, or all of:
(a) to determine the one or more work parameters and associated manipulated variables using suitable sensor system(s) and to transfer or transmit them (wired and/or wirelessly) to the optimization method;
(b) the optimization method may adapt the non-linear dynamic process model in a model adaptation step and may then derive the static process model component;
(c) the optimized work parameters may then be determined using the derived static process model component and the quality parameters specifiable by the operator of the agricultural work machine;
(d) the determined optimized work parameters may be transferred or transmitted to the control loop structure, and optimized work parameters may be determined on the basis of the transferred work parameters and the transferred quality parameters;
(e) the optimized work parameters may then be set on or programmed into the working units of the agricultural work machine and the resulting quality criteria of the process P may be determined;
(f) then the determined quality parameters may be compared with the predefined quality parameters in a test step depending on a limit value, wherein the control loop structure may be activated when the determined quality parameter(s) exceed the limit value, and the activation of the control loop structure may then be omitted or terminated if the determined quality parameter(s) do not or no longer exceed the limit value; and
(g) when the control loop structure is activated, the work parameters determined by the control loop structure may be specified to the particular working unit (e.g., command(s) may be sent to the particular working unit(s) in order to configure the particular working unit(s) with the work parameters.

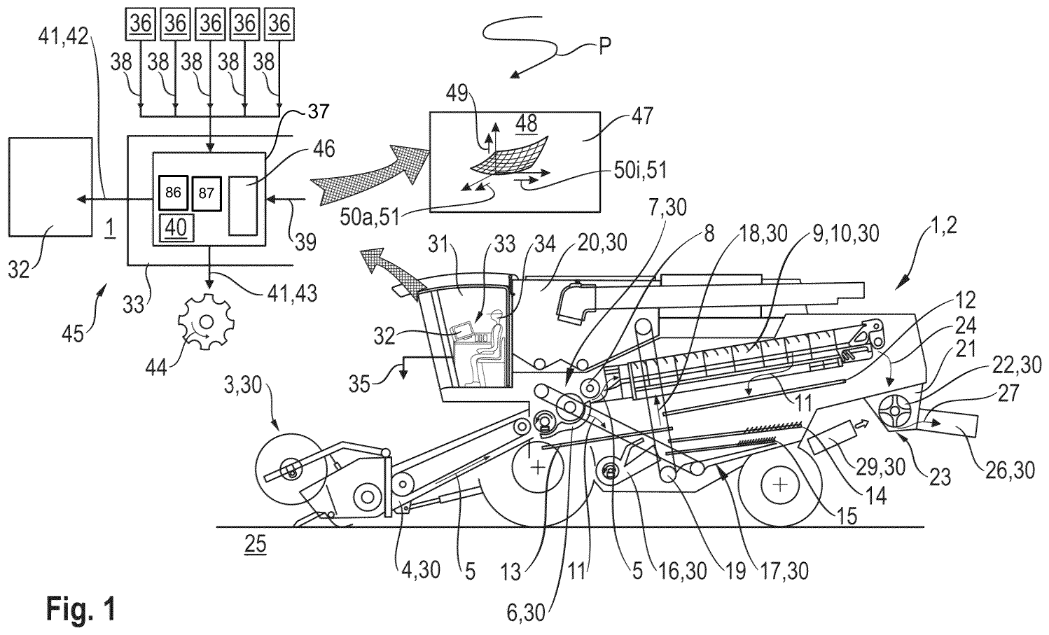

Referring to the figures, the agricultural work machine 1, which may comprise a combine harvester 2, is schematically represented in FIG. 1. The agricultural work machine 1 may receive a grain header 3 in its front area that is connected in a known manner to the inclined conveyor 4 of the combine harvester 2. The harvested material flow 5 passing through the inclined conveyor 4 may be transferred in the upper rear region of the inclined conveyor 4 to the threshing units 7 of the combine harvester 2, which may be at least partially surrounded by a so-called threshing concave 6 on the bottom. A diverter roller 8 downstream from the threshing units 7 may divert the harvested material flow 5 out of the threshing units 7 in their rearward area so that the flow is immediately transferred to a separating device 10, which may be designed as a separating rotor assembly 9. In one or some embodiments, the separating device 10 may also be designed as a known, and therefore not shown, straw walker. In one or some embodiments, the separating device may be designed with a single rotor or two rotors, or the threshing units 7 and the separating device 10 may be combined to form a single- or double-rotor axial flow threshing and separating device. In the separating device 10, the harvested material flow 5 may be conveyed in such a way that free-moving grains 11 contained in the harvested material flow 5 are separated in the downstream region of the separating device 10. The grains 11, which may be deposited both on the threshing concave 6 and in the separating device 10, may be fed over a returns pan 12 and a feed pan 13 of a cleaning device 17 comprising (or consisting of) a plurality of screening levels 14, 15 and a blower 16. The cleaned flow of grains 18 may then be transferred by means of elevators 19 to a grain tank 20.

In the rear region of the separating device 10, a shredding device 23, designed as a straw chopper 22 and surrounded by a funnel-shaped housing 21, may be associated with the separating device 10 in the shown embodiment. The straw 24 leaving the separating device 10 in the rear region may be fed to the straw chopper 22 at the top. In a manner not shown, the straw 24 may also be diverted after the separating device 10 so that it is deposited directly on the ground 25 in a swath. In the outlet area of the straw chopper 22, the material flow, comprising (or consisting of) the chopped straw 24 and the non-grain components separated in the cleaning device 17, may be transferred to a material distribution device 26 which discharges the residual material flow 27 in such a way that a wide distribution of the residual material flow 27 occurs on the ground 25. In the embodiment shown here, the residual material flow 28 separated in the cleaning device 17 may be discharged into the straw chopper 22 using a so-called chaff spreader 29, where it is ultimately conveyed out of the combine harvester 2 as a common residual material flow 27 via the material distribution device 26. In the following, any one, any combination or all of the grain header 3, the inclined conveyor 4, the threshing units 7 and the threshing concave 6 assigned thereto, the separating device 10, the cleaning device 17, the elevators 19, the grain tank 20, the straw chopper 22, the material distribution device 26 and the chaff spreader 29 may be referred to as working units 30 of the agricultural work machine 1.

Furthermore, the agricultural work machine 1 has a vehicle cabin 31 in which is arranged or positioned at least one control and regulating device 33 provided with a display unit 32, through which a plurality of processes P, which are to be described in more detail, may be controlled automatically or initiated by the operator 34 of the agricultural work machine 1. The control and regulating device 33 may communicate (e.g., wired and/or wirelessly) with a plurality of sensor systems 36 via a so-called bus system 35 in a manner known per se. An example of the structure of the sensor systems 36 is described in US Patent Application Publication No. 2003/066277 A1, the entirety of which is hereby incorporated herein.

Furthermore, FIG. 1 shows a schematic representation of the display unit 32 of the control and regulating device 33 and the computing unit 37 associated with the control and regulating device 33 and coupled to the display unit 32. Computing unit 37 may include at least one processor 86 and at least one memory 87. The at least one processor 86 and at least one memory 87 may be in communication with one another. In one or some embodiments, the processor 86 may comprise a microprocessor, controller, PLA, or the like. In one or some embodiments, memory 87 may comprise memory unit 68. Alternatively, memory 87 may be separate from memory unit 68. Similarly, the memory 87 may comprise any type of storage device (e.g., any type of memory). Though the processor 86 and the memory 87 are depicted as separate elements, they may be part of a single machine, which includes a microprocessor (or other type of controller) and a memory. Alternatively, the processor 86 may rely on the memory 87 for all of its memory needs. The memory 87 may comprise a tangible computer-readable medium that include software that, when executed by the processor 86 is configured to perform any one, any combination, or all of the functionality described herein regarding any computing device.

The processor 86 and the memory 87 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In this regard, the computing unit 37 may be configured to process any one, any combination, or all of the following into a plurality of output signals 41: the information 38 generated by the sensor systems 36; external information 39; or information 40 saved in the computing unit 37 itself (such as expert knowledge). The output signals 41 may comprise one or both of display control signals 42 or working unit control signals 43, wherein the display control signals 42 may determine the contents of the display unit 32 and the working unit control signals 43 may cause the change in the various work parameters 44 of the working units 30 of the agricultural work machine 1 (e.g., the working unit control signals 43 may comprise commands that are sent to the various working units 30 of the agricultural work machine 1 in order to configure the respective working units 30 to change its respective work parameters 44), wherein arrow 44 may symbolically represent the threshing drum rotational speed. In one or some embodiments, the control and regulating device 33 with the display unit 32 associated therewith and the computing unit 37 may be part of the driver assistance system 45, which is described in more detail below.

In one or some embodiments, a process optimization module 46 is associated with the driver assistance system 45, wherein the process optimization module 46 may be a component of the computing unit 37 (e.g., a software module stored in the memory 87 and executed by the processor 86). In one or some embodiments, one or more process models 47 may be associated with the process optimization module 46, which may describe the processes P that occur in the agricultural work machine 1 and which are described in more detail below. In one or some embodiments, the one or more process models 47 are described by performance maps 48, wherein the relationship between quality parameters 49 and work parameters 50a . . . i of the agricultural work machine 1 may be defined in each respective performance map 48.

The processes P described by the particular process model 47 may be, for example, any one, any combination, or all of the threshing process, the separation process; or the cleaning process of the harvested material flow 5. Other processes P are contemplated. The quality parameters may be, for example, the quality parameters of any one, any combination, or all of “threshing loss”, “broken grain fraction”, “separation loss”, “cleaning loss”, “threshing unit load” or “fuel consumption”, which are known per se and are therefore not described in more detail here. The work parameters 50a . . . i of the agricultural work machine may comprise, on the one hand, parameters relating to the harvested material flow 5, such as any one, any combination, or all of the harvested material throughput, the layer height of the harvested material flow 5 detected in the agricultural work machine, or the moisture of the harvested material flow 5. On the other hand, the work parameters 50a . . . i may comprise parameters relating to the working units 30 of the agricultural work machine, such as one or both of threshing drum rotational speed 44 or the rotational speed of the blower 16 associated with the cleaning device 17. These are merely examples and other parameters are contemplated. The example shown in FIG. 1 for a map 48 describing a process model 47 may, for example, describe the quality parameter 49 of “separation loss” depending on the work parameters of threshing drum rotational speed 44, 50a and the layer height 50i related to the harvested material flow 5.

With such a structure of an agricultural work machine 1 (which may be designed as a combine harvester 2) comprising the described driver assistance system 45 (which may be configured to automatically monitor and set the work parameters 44, 50a . . . i and/or the quality parameters 49 of the combine harvester 2), a driver assistance system 45 may support the operator 34 of the combine harvester 2 in the operation of the combine harvester 2. This may initially be possible because the driver assistance system 45 is assigned a process model 47 comprising a performance map 48, and the process model 47 may define the particular quality parameter 49 depending on manipulated variables 51, in this case the work parameters 50a . . . i, and the driver assistance system 50 may be configured to automatically determine optimized work parameters 50a . . . i of the agricultural working machine 1 depending on the particular process model 47, discussed further below.

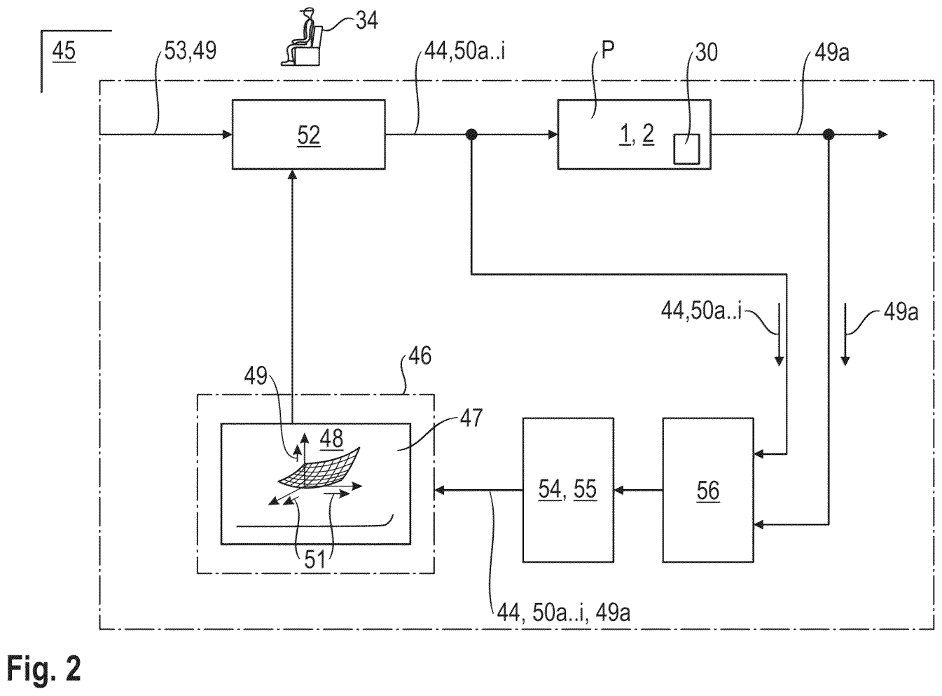

For a better understanding, general aspects of the driver assistance system 45 known from the prior art will first be described in detail in FIG. 2. In an optimization step 52, the driver assistance system 45 may optimize the work parameters 44, 50a . . . i of the agricultural work machine 1 (designed as a combine harvester 2). The optimization of the work parameters 44, 55a . . . i may depend on a preselected harvesting process strategy 53 as part of determining the optimization step 52. In one or some embodiments, the harvesting process strategy 53 may be specified by the operator 34 (e.g., the operator may select, via a touchscreen in the vehicle cabin 31 the harvesting process strategy 53 from a plurality of harvesting process strategies 53), and in the simplest case may define the quality parameters 49 to be achieved, such as maximum permissible grain losses and/or a purity of the grains 11 to be achieved, to name two quality parameters 49 only by way of example. The optimized work parameters 44, 55a . . . i automatically determined in the optimization step 52 may then be automatically transferred to the process P and automatically set in the particular working units 30 of the combine harvester 2 (e.g., via transmitting command(s)), such as an optimized rotational speed 44 of a threshing drum assigned to the threshing units 7. The driver assistance system 45 may then determine the quality parameters 49a resulting from an adjustment of the work parameters 44, 55a . . . i.

One or both the optimized work parameters 44, 50a . . . i and the determined quality parameters 49a may be automatically transmitted to the process optimization module 46 in a model adaptation step 54, wherein the process model 47 may be adapted in a known manner depending on the transmitted parameters 44, 50a . . . i, 49a if the saved process model 47 no longer describes the actual process P sufficiently well. The model adaptation step 54, known from the prior art, may be designed as a so-called stationary model adaptation 55, in which quasi-stationary states are first determined for the manipulated variables 51 and the determined quality parameters 49a in a data preprocessing step 56. The values for the manipulated variables 51 and the determined quality parameters 49a corresponding to the quasi-stationary state may then be automatically transferred to the process optimization module 46 for automatic adaptation of the process model 47. This adjustment of the process model 47 to the real process P known from the prior art is referred to below as inertial or stationary model adaptation 55 since a certain response time is needed until the saved process model 47 is adapted to the real process P. If conditions describing the process P, such as the harvested material throughput or the moisture of the harvested material flow 5, change abruptly and/or only for a short time, this control structure may have the disadvantage that it cannot react sufficiently quickly to the changing conditions of the process P, which ultimately results in the fact that the quality parameters 49 specified by the selected harvesting process strategy 53 cannot be met sufficiently well. In one or some embodiments, the disclosure described herein may at least partly ameliorate such problem.

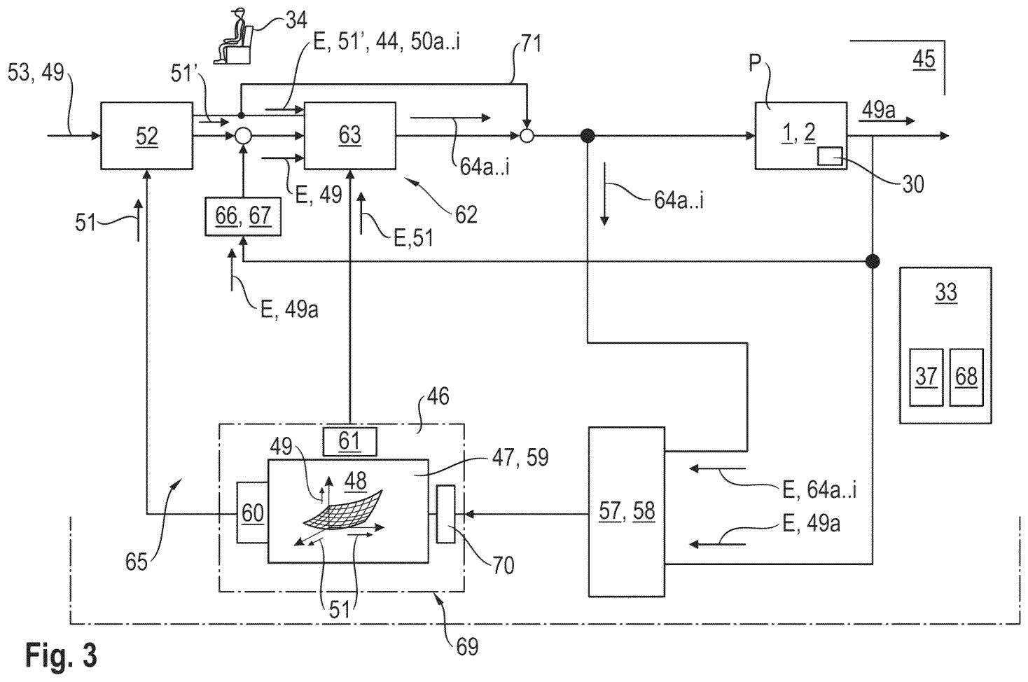

In particular, FIG. 3 shows details of the driver assistance system 45 with the process optimization module 46 assigned thereto, in which the process model 47 and the performance maps 48 assigned to the process model 47 are saved, wherein the process model 47 may describe the relationship between any two or all of work parameters 50a . . . i of a working unit 30, the manipulated variables 51, and the quality parameters 49 so that the optimization method 65 to be implemented by the driver assistance system 45 (and explained herein in more detail) may be designed as a map control 69.

In one or some embodiments, a model adaptation step 57 is assigned to the process model 47 which, explained further below, is designed as a dynamic model adaptation 58 so that the saved process model 47 is designed as a non-linear dynamic process model 59, wherein the non-linear dynamic process model 59 is composed of a static process model component 60 and a dynamic process model component 61. In analogy to the saved process model 47, the non-linear dynamic process model 59 may also represent the relationship between any two or all of: work parameters 50a . . . i of a working unit 30; the manipulated variables 51; and the quality parameters 49.

In one or some embodiments, the map control 69 is configured to automatically specify the work parameters 44, 50a . . . i of the agricultural work machine 1 and limit values 66, to be described in more detail, for the control loop structure 62, wherein a self-adjusting controller 63 (which may include at least one processor and at least one memory) is assigned to the control loop structure 62, with the self-adjusting controller 63 being configured to automatically monitor the quality parameters 49, 49a of the process.

In the static process model component 60, optimized manipulated variables 51′, the work parameters 44, 50a . . . i, may first be first determined in an optimization step 52 from the quality parameters 49 assigned to the selected harvesting process strategy 53 and the manipulated variables 51 derived from the process model 47.

In one or some embodiments, the dynamic process model component 61 may comprise a control loop structure 62 comprising the self-adjusting controller 63. Input variables E of the self-adjusting controller 63 may initially be any one, any combination, or all of the optimized manipulated variables 51′, the optimized work parameters 44, 50a . . . i, and the quality parameters 49 defined in the selected harvesting process strategy 53. In addition, the quality parameters 49a, automatically achieved or generated in process P by automatically applying the optimized work parameters 44, 50a . . . i, may form input variables E of the self-adjusting controller 63. Furthermore, the manipulated variables 51 automatically determined in the model adaptation step 57 may be automatically transferred as further input variables E to the self-adjusting controller 63. In the self-adjusting controller 63, the defined quality parameters 49 may be automatically compared with the achieved quality parameters 49a. Responsive to the self-adjusting controller 63 determining that the defined quality parameter 49 and the achieved quality parameter 49a deviate from each other, the self-adjusting controller 63 may automatically generate dynamically adapted work parameters 64a . . . i, taking into account the saved process model 47, and may automatically set in the particular working units 30 in the agricultural work machine 1 (designed as a combine harvester 2) describing the process P. At the same time, these dynamically adapted work parameters 64a . . . i may also be automatically transferred to the model adaptation step 57.

By designing the process model 47 as a dynamic non-linear process model 59 in such a way that the dynamic non-linear process model 59 comprises a static process model component 60 and a dynamic process model component 61, wherein at least the manipulated variables 51 in the static process model component 60 automatically pass through an optimization step 52 and those in the dynamic process model component 61 automatically pass through a control loop structure 62, it may be ensured that the driver assistance system 45 (and particularly the optimization of the work parameters 50a . . . i) may automatically adapt quickly to the real harvesting conditions, the process P, such as reacting quickly to abrupt changes in the harvesting conditions. In this way, the optimization step 52 and the control loop structure 62 may form an optimization method 65 which may be configured to adapt the process model 47, 59 in a model adaptation step 57 in such a way that the dynamic non-linear process model component 61 is configured to be derived from the monitoring of the quality parameters 49, 49a and, using a parameter estimation method 70, to determine the steady-state process model component 60 of the process P, wherein the one or more manipulated variables 51 and the one or more quality parameters 49a dependent on the particular manipulated variable 51 may form the input variables of the optimization method 65 in the model adaptation step 57.

In one or some embodiments, the non-linear dynamic process model 59, such as the dynamic process model component 61, may be designed as a self-learning process model, and the parameter estimation method 70 may be formed by an LMN-FIR model (local model networks with local finite impulse response models).

The described control loop structure 62 is such that it may affect a dynamic adaptation of the process P until the saved process model 47, 59 has been adjusted to the process P. In this context, the adjustment of the saved process model 47, 59 may be achieved by automatically transferring the dynamic work parameters 64a . . . i generated by the self-adjusting controller 63 and the determined quality parameters 49a as input variables E to the model adaptation step 57 causing the dynamic model adaptation 58. In this way, the saved model 47 may be automatically adapted stepwise to the conditions of the process P. To ensure that the control loop structure 62 only effects a dynamic adaptation of the process P if the achieved quality parameters 49a no longer correspond to the quality parameters 49 defined in the selected harvesting process strategy 53, it is further provided that the quality parameters 49, 49a may be assigned limit values 66, and it may initially be determined in a test step 67 whether or not the achieved quality parameter 49a is still within the limit value 66 for the quality parameter 49. Responsive to automatically determining that the determined quality parameter 49a exceeds the defined limit value 66, the control loop structure 62 may be automatically activated; conversely, the intervention of the control loop structure 62 in the process P may be omitted or ended responsive to determining that the defined limit value 66 is not exceeded. This may also ensure that the control loop structure 62 remains activated until the optimized work parameters 50a . . . i derived from the non-linear dynamic process model 59 satisfy the quality parameters 49 of the process P.

So that the described optimization method 65 may be used efficiently, the optimization method 65 may be integrated into the driver assistance system 45 assigned to the agricultural work machine 1, wherein the particular process model 47, 59 may be saved in a memory unit 68 of the driver assistance system 45 assigned to the control and regulating device 33 accommodating the computing unit 37 so that the computing unit 37 is configured to operate the optimization method 65 using the saved process model 47 with the dynamic model adaptation 58. As described, the driver assistance system 45 may be configured to automatically determine and automatically make available the work parameters 44, 50a . . . i and associated manipulated variables 51 using suitable sensor systems 36 (see FIG. 1).

Therefore, the driver assistance system 45 implementing the optimization method 65 may be such that the map control 69 derives the work parameters 44, 50a . . . i and the quality parameters 49, 49a from the static process model component 60 of the process P describing the machine behavior as well as the user specifications, the predeterminable harvesting process strategies 53, and the technical limits of the agricultural work machine 1 by optimization. Using the control loop structure 62 to which the self-adjusting controller 63 may be assigned, the operation of the agricultural work machine 1 (designed as a combine harvester 2) may be automatically controlled by automatically monitoring the quality parameters 49, 49a. In addition, the control loop structure 62 may make it possible to automatically adapt the saved process model 47 with dynamic model adaptation 58, wherein in this case the described non-linear dynamic process model component 61 of the quality parameters 49, 49a may be automatically determined by using a parameter estimation method 70, and the process model 47 of the stationary machine behavior may be determined therefrom.

The map control 69 therefore may perform two tasks, namely the direct automatic specification of the work parameters 44, 50a . . . i of the working units 30 and the automatic specification of the limit values 66 of the control loop structure 62, wherein the self-adjusting controller 63 assigned to the control loop structure 62 may automatically monitor the quality parameters 49, 49a, wherein the control loop structure 62 may be designed such that the self-adjusting controller 63 is configured either as a so-called standard controller for automatically maintaining a target value, or as a limit load controller, which may be automatically activated responsive to automatically determining exceeding the limit value 66 and/or automatically deactivated again responsive to automatically determining falling below the limit value 66.

Consequently, the optimization method may be configured such that, on the one hand, it implements an adaptive feedforward control 71 of the process P and, in addition, enables dynamic monitoring and control of the quality parameters 49, 49a. This may mean that the basic setting of the work parameters 44, 50a . . . i may be derived from the static process model component, and maintenance of the specified quality parameters 49, 49a may be effected by the control loop structure 62 so that the resulting control structure is designed as adaptive control with feedforward control.

A simple implementation of this method may be achieved in that the optimized work parameters 44, 50a . . . i are first automatically determined using the derived static process model component 60 and the quality parameters 49 specifiable by the operator 34 of the agricultural work machine 1. The optimized work parameters 44, 50a . . . i automatically determined in this way may then be automatically transferred to the control loop structure 62 in order to automatically determine optimized work parameters 64a . . . i on the basis of the transferred work parameters 44, 50a . . . i and the transferred quality parameters 49. The optimized work parameters 64a . . . i may then be automatically set in the working units 30 of the agricultural work machine 1, and the resulting quality parameters 49a of the process P may be automatically determined. In the subsequent step, the determined quality parameters 49a may be automatically compared with the predefined quality parameters 49 in a test step 67 depending on a limit value 66, wherein the control loop structure 62 is automatically activated upon exceeding the limit value 66 (e.g., responsive to automatic comparison with the limit value 66), and the activation of the control loop structure 62 is then automatically omitted or automatically terminated if the limit value 66 is not or no longer exceeded (e.g., responsive to automatic comparison with the limit value 66). If the control loop structure 62 is automatically activated, the work parameters 64a . . . i automatically determined by the control loop structure 62 may be automatically specified to the particular working unit 30.

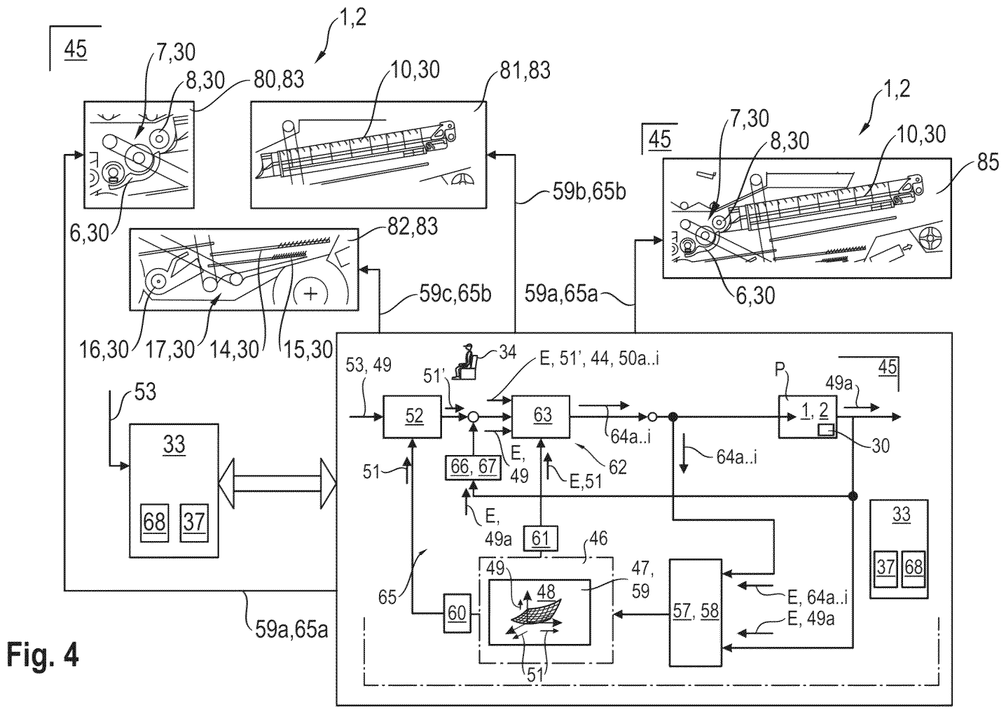

FIG. 4 describes in more detail the application of the described dynamic process model 59 in an agricultural work machine 1 designed as a combine harvester 2. First of all, the driver assistance system 45 may operate a so-called automated unit-based control and regulation of the agricultural work machine 1. In this context, it is known that the threshing units 7, the threshing concave 6 assigned to them and the diverter roller 8 are combined into a so-called automatic threshing unit 80. It is also known to design the separating device 10 as a so-called automatic separating unit 81. In addition, so-called automatic cleaning units 82 are described in the prior art, which are essentially composed of the working units 30 of a cleaning device 17 and comprise at least the blower 16 and the screening levels 14, 15.

The automatic processing units 83 mentioned here, namely the automatic threshing unit 680, the automatic separating unit 781 and the automatic cleaning unit 782, have the basic structure of an automated unit in common, namely that the driver assistance system 45 with its associated control and regulating device 33 and the computing unit 37 and memory unit 68 associated therewith is configured to autonomously determine individual work parameters 44, 50a . . . i of the particular working units 30 and to automatically specify them to the particular working unit 30, wherein the basis for determining the particular work parameters 44, 50a . . . i is the described user selection of harvesting process strategies 53. The driver assistance system 45 is such that process models 47, 59 describing the particular automatic processing unit 83 may be saved in the memory unit 68 of the driver assistance system 45, and the computing unit 37 may be configured to operate the automatic processing unit 83 according to FIG. 3 using the saved process models 47, 59. Further, the particular automatic processing unit 83 may be configured to automatically optimize work parameters 44, 50a . . . i of the working unit(s) 30 and to automatically specify the optimized work parameters 50a . . . i, 64a . . . i to the particular working unit 30. As previously described, the process model 47 is designed as a dynamic non-linear process model 59. In a first embodiment relating to the automatic processing unit 83, the automatic processing machines of the automatic threshing unit 80, automatic separating unit 81 and automatic cleaning unit 82 are each assigned a separate dynamic process model 59a . . . c and associated optimization method 65a . . . c so that the operation of each automatic processing unit 83 may be automatically optimized independently of the operation of the other automatic processing unit 83. In another embodiment, the automatic threshing unit 80 and the automatic separating unit 81 may be combined into a common automatic separating unit 85, wherein the common automatic separating unit 85 may then be assigned a single dynamic process model 59d and associated automatic optimization method 65d, which may automatically optimize both the operation of the threshing units 7 and the working units 30 of the threshing concave 6 and diverter roller 8 assigned to them, as well as the separating device 10. It is also contemplated that a common process model 47 and associated optimization method 65 may be assigned to any one, any combination or all of the automatic threshing unit 80, the automatic separating unit 81, and the cleaning unit 82.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Agricultural work machine | 34 | Operator |
| 2 | Combine harvester | 35 | Bus system |
| 3 | Grain header | 36 | Sensor system |
| 4 | Inclined conveyor | 37 | Computing unit |
| 5 | Harvested material flow | 38 | Internal information |
| 6 | Threshing concave | 39 | External information |
| 7 | Threshing unit | 40 | Information |
| 8 | Deflection drum | 41 | Output signal |
| 9 | Separating rotor assembly | 42 | Display signal |
| 10 | Separating device | 43 | Working unit signal |
| 11 | Grains | 44 | Operating parameter |
| 12 | Returns pan | 45 | Driver assistance system |
| 13 | Feed pan | 46 | Process optimization mode |
| 14 | Screening level | 47 | Process Model |
| 15 | Screening level | 48 | Performance map |
| 16 | Fan | 49 . . . 49a | Quality parameter |
| 17 | Cleaning device | 50a . . . i | Operating parameter |
| 18 | Grain flow | 51 | Manipulated variable |
| 19 | Elevator | 51′ | Optimized manipulated variable |
| 20 | Grain tank | 52 | Optimization step |
| 21 | Funnel-shaped housing | 53 | Harvesting process strategy |
| 22 | Straw chopper | 54 | Model adaptation step |
| 23 | Shredding device | 55 | Stationary model adaptation |
| 24 | Straw | 56 | Data preprocessing step |
| 25 | Ground | 57 | Model adaptation step |
| 26 | Crop distribution device | 58 | Dynamic model adaptation |
| 27 | Residual material flow | 59 | Dynamic process model |
| 28 | Residual material flow | 60 | Static process model component |
| 29 | Chaff spreader | 61 | Dynamic process model component |
| 30 | Working unit | 62 | Control loop structure |
| 31 | Vehicle cabin | 63 | Self-adjusting controller |
| 32 | Display unit | 64a . . . i | Dynamic work parameter |
| 33 | Control and regulation device | | |
| 65 | Optimization method | | |
| 66 | Limit value | | |
| 67 | Test step | | |
| 68 | Memory unit | | |
| 69 | Map control | | |
| 70 | Parameter estimation method | | |
| 71 | Adaptive feedforward control | | |
| 80 | Automated threshing unit | | |
| 81 | Automated separating unit | | |
| 82 | Automated cleaning unit | | |
| 83 | Automated process unit | | |
| 84 | | | |
| 85 | Common automatic separating unit | | |
| 86 | Processor | | |
| 87 | Memory | | |
| D | Input variable | | |
| P | Process | | |

1. An agricultural work machine comprising:
a driver assistance system comprising at least one process model, wherein the at least one process model comprises one or more performance maps and a dynamic non-linear process model, wherein the dynamic non-linear process model comprises a static process model component and a dynamic process model component;
wherein the driver assistance system is configured as a map control and further configured to:
determine one or more optimized work parameters as one or more manipulated variables; and
determine, based on the one or more optimized work parameters, one or more quality parameters of the agricultural work machine; and
wherein at least the manipulated variables in the static process model component run through an optimization step and, in the dynamic process model component, through a control loop structure.

2. The agricultural work machine of claim 1, wherein the map control defined by the at least one process model is configured to specify the one or more optimized work parameters of the agricultural work machine and limit values for the control loop structure; and
further comprising a self-adjusting controller assigned to the control loop structure and configured to monitor the one or more quality parameters of a process.

3. The agricultural work machine of claim 2, wherein the optimization step and the control loop structure form an optimization method which is configured to adapt the at least one process model in a model adaptation step so that the dynamic non-linear process model component is configured to determine the static process model component of a process from the monitoring of the one or more quality parameters and using a parameter estimation method; and
wherein the one or more manipulated variables comprising the optimized work parameters and the one or more quality parameters dependent on a respective manipulated variable form input variables to the optimization method.

4. The agricultural work machine of claim 3, wherein, in the optimization step, optimized manipulated variables are determined from the manipulated variables derived from the at least one process model and specified quality parameters.

5. The agricultural work machine of claim 4, wherein the control loop structure comprises a self-adjusting controller and has as input the manipulated variables optimized in the optimization step, the specified quality parameters and the quality parameters determined depending on the optimized manipulated variables; and
wherein the self-adjusting controller is configured to derive optimized manipulated variables from a comparison of one or more specified quality parameters with one or more quality parameters that are determined, and transfer the optimized manipulated variables to the process and model adaptation step of a dynamic model adaptation.

6. The agricultural work machine of claim 5, wherein the one or more quality parameters that are determined are transferred to the model adaptation step as an input variable.

7. The agricultural work machine of claim 3, wherein the dynamic non-linear process model is configured as a self-learning process model; and
wherein the parameter estimation method is formed by a LMN-FIR (local model networks with local finite impulse response) model.

8. The agricultural work machine of claim 3, wherein the optimization method is integrated into the driver assistance system assigned to the agricultural work machine;
wherein the driver assistance system includes a particular process model for a control and regulation device accommodating a computing unit;
wherein the computing unit is configured to operate the optimization method using the particular process model; and
wherein the driver assistance system is further configured:
(a) to determine the one or more optimized work parameters as the one or more manipulated variables using one or more sensor systems and to transfer the one or more optimized work parameters as the one or more manipulated variables to the optimization method;
(b) the optimization method is configured to adapt the non-linear dynamic process model in a model adaptation step and then to derive the static process model component;
(c) the static process model component is configured to determine the one or more optimized work parameters using the one or more quality parameters specifiable by an operator of the agricultural work machine;
(d) the control loop structure is configured to receive the one or more optimized work parameters that are determined and the one or more quality parameters, and to determine the one or more optimized work parameters on a basis of the one or more optimized work parameters and the one or more quality parameters;
(e) the optimized work parameters are then configured to be set in one or more working units of the agricultural work machine, and the one or more quality parameters are determined;
(f) a test step is configured to compare the one or more quality parameters that are determined with one or more predefined quality parameters, wherein, responsive to the comparison exceeding a limit value, the control loop structure is configured to activate, and wherein, responsive to the comparison no longer exceeding the limit value, the control loop structure is configured to terminate; and
(g) responsive to the control loop structure being activated, the control loop structure is configured to determine the one or more optimized work parameters and specify the one or more optimized work parameters to a particular working unit.

9. The agricultural work machine of claim 1, further comprising one or more working units; and
wherein the driver assistance system is configured to automatically set the one or more manipulated variables that are optimized in the working units of the agricultural work machine.

10. The agricultural work machine of claim 1, wherein the control loop structure is configured to effect a dynamic adaptation of a process of generating the one or more manipulated variables and the determining of the one or more quality parameters before the at least one process model that has been saved has been adjusted to the process.

11. The agricultural work machine of claim 1, wherein the non-linear dynamic process model describes a relationship between work parameters of a respective working unit and the quality parameters.

12. The agricultural work machine of claim 1, wherein the agricultural work machine is further configured to:
determine, in a test step, whether one or more achieved quality parameters are within one or more limit values assigned to the one or more quality parameters; and
wherein, responsive to determining that the one or more achieved quality parameters exceed the one or more limit values assigned to the one or more quality parameters, the control loop structure is configured to activate; and
wherein, responsive to determining that the one or more achieved quality parameters is within the one or more limit values assigned to the one or more quality parameters, the control loop structure is configured to terminate.

13. The agricultural work machine of claim 1, wherein the control loop structure is configured to remain active until the optimized work parameters derived from the non-linear dynamic process model meet one or more quality criteria.

14. The agricultural work machine of claim 1, further comprising a plurality of working units of the agricultural work machine;
wherein each of the plurality of working units have an associated respective automated process unit;
wherein the at least one process model comprises respective process models describing respective automated process units of the plurality of working units; and
wherein at least one computing unit is configured to use process models in order to optimize the one or more optimized work parameters of the plurality of working units and to specify the one or more optimized work parameters for respective working units.

15. The agricultural work machine of claim 14, wherein the plurality of working units comprise one or more of a threshing unit, a separating unit, or a cleaning unit;
wherein one or more automated process units comprise one or more of: an automatic threshing unit comprising the threshing unit and an associated threshing unit process model; an automatic separating unit comprising the separating unit and an associated separating unit process model; or an automatic cleaning unit comprising the cleaning unit and an associated cleaning unit process model.

16. The agricultural work machine of claim 15, wherein a common process model is assigned to at least the automatic threshing unit and the automatic separating unit.

17. The agricultural work machine of claim 15, wherein a common process model is assigned to the automatic threshing unit, the automatic separating unit, and the cleaning unit.

18. The agricultural work machine of claim 14, wherein the plurality of working units comprise a threshing unit, a separating unit, or a cleaning unit;
wherein one or more automated process units comprise: an automatic threshing unit comprising the threshing unit and an associated threshing unit process model; an automatic separating unit comprising the separating unit and an associated separating unit process model; and an automatic cleaning unit comprising the cleaning unit and an associated cleaning unit process model.
